(19) United States
(12) Patent Application Publication
(10) Pub. No.: US 2017/0251512 A1
(43) Pub. Date: Aug. 31, 2017

(54) CONFIGURED CONDITION FOR RADIO RESOURCE CONTROL CONNECTION RE-ESTABLISHMENT PROCEDURE

(71) Applicant: NOKIA TECHNOLOGIES OY, Espoo (FI)

(72) Inventors: Jussi-Pekka KOSKINEN, Oulu (FI); Jarkko KOSKELA, Oulu (FI)

(73) Assignee: NOKIA TECHNOLOGIES OY, Espoo (FI)

(21) Appl. No.: 15/114,169

(22) PCT Filed: Feb. 2, 2015
(86) PCT No.: PCT/US15/14106

§ 371 Date: Jul. 26, 2016

Related U.S. Application Data
(60) Provisional application No. 61/934,372, filed on Jan. 31, 2014.

(51) Int. Cl. H04W 76/02; H04W 24/10; H04W 24/08; H04B 17/318

(52) U.S. Cl. CPC H04W 76/028; H04W 76/027; H04B 17/318; H04W 24/10; H04W 24/08

(57) ABSTRACT

Various communication systems may benefit from techniques and devices for properly re-establishing connections. For example, communication systems of the third generation partnership project may benefit from a configured condition for radio resource control connection re-establishment. A method can include detecting, by a user equipment, a predetermined condition. The method can also include, based on the detected predetermined condition, at least one of initiating sending an indication to a network element. The indication can include a measurement result of a cell serving the user equipment, a measurement result of a neighbor cell, a random access problem indication, an indication from radio link control (RLC) that a maximum number of retransmissions has been reached, or any combination thereof.

### CROSS-REFERENCE TO RELATED APPLICATION

This application is related to and claims the benefit and priority of U.S. Provisional Patent Application No. 61/934,372 filed Jan. 31, 2014, the entirety of which is hereby incorporated herein by reference.

### BACKGROUND

Field

Various communication systems may benefit from techniques and devices for properly re-establishing connections. For example, communication systems of the third generation partnership project may benefit from a configured condition for radio resource control connection re-establishment.

Description of the Related Art

The third generation partnership project (3GPP) includes enhancements for heterogeneous network (HetNet) mobility in order to make the mobility more robust in future network deployment scenarios. HetNet can refer to a network having a mixture of deployed cell types, such as macro cells and pico cells.

Furthermore, 3GPP aims to minimize signaling overhead and user equipment (UE) power consumption with infrequent and frequent small data transfer. Such traffic is typical for machine type communication (MTC) devices as well as for smart phones when generating only background traffic. The inter-arrival of traffic bursts may vary a lot. For example, for MTC devices the inter-arrival of traffic bursts may be of some tens of seconds, minutes, days, or even weeks. By contrast, with smart phones the interval may be counted in seconds or tens of seconds.

The data amount per burst may be small, which may result in high signaling overhead with respect to transferred payload data. In order to minimize the signaling overhead in such irregular traffic, mobility information can be used, in addition to traffic pattern, as an input when deciding whether to release the connection or keep the user equipment in connected mode.

Network assisted re-establishment of a radio resource control (RRC) connection may need to involve mechanisms to recover quickly from radio link failure (RLF) and/or handover failure (HOF) and to minimize impact on application layer. Conventionally, it is uncertain how to quantify improvement over existing baseline and other mechanisms. For example, conventionally it is uncertain what contributes most to the re-establishment delay or how interruption due to re-establishment can be reduced.

One option for enhancements for a re-establishment procedure is that the UE could select cell where re-establishment would not succeed. Such behavior may have negative end user impact and key performance indicators (KPIs).

Measurement reporting and RRC connection re-establishment procedures are specified in 3GPP technical specification (TS) 36.331, the entirety of which is hereby incorporated herein by reference. Sections 5.3.7 and 5.5.5 provide particular examples.

In particular, in such an approach the UE is configured for measurement reporting. Reports are used by the network e.g. for determining whether it would be beneficial to perform a new RRC connection re-configuration or handover procedure. The UE performs the RRC connection re-establishment procedure upon detecting radio link failure, handover failure, mobility from evolved universal terrestrial radio access (E-UTRA) failure, integrity check failure indication from lower layers, or an RRC connection reconfiguration failure.

### SUMMARY

According to a first embodiment, a method can include detecting, by a user equipment, a predetermined condition. The method can also include, based on the detected predetermined condition, at least one of initiating sending an indication to a network element for delayed radio resource control connection re-establishment or starting a radio resource control connection re-establishment.

In a variant, the method can also include, after the indication is sent, waiting for confirmation of sent indication or response message from the network element.

In a variant, the starting the radio resource control connection re-establishment can be performed after the waiting.

In a variant, the predetermined condition can include at least one of a condition of a cell serving the user equipment, a radio condition, a quality related condition, or a data communication condition.

In a variant, the indication can be configured to indicate that the predetermined condition has been met.

In a variant, the indication can include at least one measurement result of a cell serving the user equipment or a neighbor cell of the cell serving the user equipment.

In a variant, the indication includes data activity related information.

According to a second embodiment, a method can include receiving an indication at a network element from a user equipment. The indication can indicate that the user equipment has detected a predetermined condition. The method can also include providing a response message from the network element in response to the indication, wherein the response message can be configured to cause the user equipment to start radio resource control connection re-establishment.

In a variant, the predetermined condition can includes at least one of a condition of a cell serving the user equipment, a radio condition, a quality related condition, or a data communication condition.

In a variant, the indication can be configured to indicate that the predetermined condition has been met.

In a variant, the indication can include at least one measurement result of a cell serving the user equipment or a neighbor cell of the cell serving the user equipment.

In a variant, the indication can include data activity related information.

In a third embodiment, a non-transitory computer-readable medium can be encoded with instructions that, when executed in hardware, perform a process. The process can include the method of the first and/or the second embodiment in any of their variants.

In a fourth embodiment, a computer program product can encode instructions that, when executed in hardware, perform a process. The process can include the method of the first and/or the second embodiment in any of their variants.

According to a fifth embodiment, an apparatus can include at least one processor and at least one memory including computer program code. The at least one memory and the computer program code can be configured to, with the at least one processor, cause the apparatus at least to detect, by a user equipment, a predetermined condition. The at least one memory and the computer program code can also be configured to, with the at least one processor, cause the apparatus at least to, based on the detected predetermined condition, at least one of initiate sending an indication to a network element for delayed radio resource control connection re-establishment or start a radio resource control connection re-establishment.

In a variant, the at least one memory and the computer program code can be configured to, with the at least one processor, cause the apparatus at least to, after the indication is sent, wait for confirmation of sent indication or response message from the network element.

In a variant, the at least one memory and the computer program code can be configured to, with the at least one processor, cause the apparatus at least to start the radio resource control connection re-establishment after the waiting.

In a variant, the predetermined condition can include at least one of a condition of a cell serving the user equipment, a radio condition, a quality related condition, or a data communication condition.

In a variant, the indication can be configured to indicate that the predetermined condition has been met.

In a variant, the indication can include at least one measurement result of a cell serving the user equipment or a neighbor cell of the cell serving the user equipment.

In a variant, indication can include data activity related information.

According to a sixth embodiment, an apparatus can include at least one processor and at least one memory including computer program code. The at least one memory and the computer program code can be configured to, with the at least one processor, cause the apparatus at least to receive an indication at a network element from a user equipment. The indication can indicate that the user equipment has detected a predetermined condition. The at least one memory and the computer program code can also be configured to, with the at least one processor, cause the apparatus at least to provide a response message from the network element in response to the indication. The response message can be configured to cause the user equipment to start radio resource control connection re-establishment.

In a variant, the predetermined condition can include at least one of a condition of a cell serving the user equipment, a radio condition, a quality related condition, or a data communication condition.

In a variant, the indication can be configured to indicate that the predetermined condition has been met.

In a variant, the indication can include at least one measurement result of a cell serving the user equipment or a neighbor cell of the cell serving the user equipment.

In a variant, the indication can include data activity related information.

According to a seventh embodiment, an apparatus can include means for detecting, by a user equipment, a predetermined condition. The apparatus can also include means for, based on the detected predetermined condition, at least one of initiating sending an indication to a network element for delayed radio resource control connection re-establishment or starting a radio resource control connection re-establishment.

In a variant, the apparatus can further include means for, after the indication is sent, waiting for confirmation of sent indication or response message from the network element.

In a variant, the means for starting the radio resource control connection re-establishment can be configured to start the radio resource control connection re-establishment after the waiting.

In a variant, the predetermined condition can include at least one of a condition of a cell serving the user equipment, a radio condition, a quality related condition, or a data communication condition.

In a variant, the indication can be configured to indicate that the predetermined condition has been met.

In a variant, the indication can include at least one measurement result of a cell serving the user equipment or a neighbor cell of the cell serving the user equipment.

In a variant, the indication can include data activity related information.

According to an eighth embodiment, an apparatus can include means for receiving an indication at a network element from a user equipment. The indication can indicate that the user equipment has detected a predetermined condition. The apparatus can also include means for providing a response message from the network element in response to the indication. The response message can be configured to cause the user equipment to start radio resource control connection re-establishment.

In a variant, the predetermined condition can include at least one of a condition of a cell serving the user equipment, a radio condition, a quality related condition, or a data communication condition.

In a variant, the indication can be configured to indicate that the predetermined condition has been met.

In a variant, the indication can include at least one measurement result of a cell serving the user equipment or a neighbor cell of the cell serving the user equipment.

In a variant, the indication can include data activity related information.

According to a ninth embodiment, a system can include apparatuses of the fifth and six embodiments. Likewise, according to a tenth embodiment, a system can include apparatuses of the seventh and eight embodiments.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates a signal flow diagram according to certain embodiments.

FIG. 3 illustrates a system according to certain embodiments.

### DETAILED DESCRIPTION

Certain embodiments provide an optimized radio resource control (RRC) connection re-establishment procedure. Certain embodiments may be applicable to a variety of communication systems and scenarios. For example, certain embodiments may be relevant to small cells and dual-connectivity and carrier aggregation scenarios.

Various features may be included in a radio resource control connection re-establishment procedure. For example, the following can be considered for initiating the RRC connection re-establishment procedure. The UE can be configured with a condition which would trigger RRC connection re-establishment procedure. Then, after the condition is triggered UE could send an indication to the network (NW) and/or start an RRC connection re-establishment procedure. If the UE sends the indication to the network, the UE may need to wait for confirmation of sent indication or response message from NW.

Various conditions can be used to trigger RRC connection re-establishment. For example, conditions for triggering RRC connection re-establishment can be related, for example, to primary cell (PCell), secondary cell (SCell), aggregated cells, master and secondary eNBs, and dual connectivity. While PCell and SCell may typically be located physically in the same base station, Master eNB and Secondary eNB may be located physically in different base stations.

More particularly, each UE can be configured with a primary component carrier, also known as Primary Cell or PCell. All the other component carriers (CCs) can be configured as secondary component carriers, also known as Secondary Cells or SCells. In other words, for each LTE-Advanced user equipment, a single CC can be defined as the UE's Primary cell (PCell). Other UEs may not necessarily use the same CC for PCell as one another. The PCell can be regarded as the anchor carrier for the terminal and can thus be used for radio link failure monitoring and similar features. If more than one CC is configured for the UE, the additional CCs can be denoted as Secondary Cells (SCells) for that particular UE. Thus, the same CC can be the PCell for one UE and an SCell for another UE.

Additionally, in general dual connectivity can refer to operation in which a given UE consumes radio resources provided by at least two different network points, which can be referred to as Master and Secondary eNBs, which are connected to each other with non-ideal backhaul, while in RRC_CONNECTED. The X2 interface can serve as an interface between MeNB and SeNB in an enhanced universal terrestrial radio access network (E-UTRAN) architecture.

If a trigger for SCell condition is met then the RRC connection re-establishment can be done for PCell. Similarly, if a trigger for SeNB is met, then the RRC connection re-establishment can be done for MeNB.

The UE can indicate that the UE supports SCell. For example, support for SCell can be indicated in a UE capability message. In that case, the UE can measure SCell, and then indicate if the trigger condition is met. The UE could also measure both PCell and SCell and indicate when a trigger condition is met. Thus, the trigger condition could be related to both PCell and SCell or only PCell or only SCell.

Additionally, or alternatively, the conditions for triggering RRC connection re-establishment can be related, for example, to radio conditions such as reference signal received power (RSRP) and received signal strength indicator (RSSI) or quality related conditions such as reference signal received quality (RSRQ), channel quality indicator (CQI), or the like measurement. Additionally, or alternatively, the conditions for triggering RRC connection re-establishment can be related, for example, to data transmission and/or reception activity. For example, there may be no need to perform re-establishment in a case where there has not been transmission and/or reception during the last X seconds, where X is a predefined number of seconds.

Triggers could be related to radio conditions, such as when measurement is above/below threshold/absolute value the trigger condition is met.

When carrier aggregation (CA) is configured, the UE may only have one radio resource control (RRC) connection with the network. At RRC connection establishment/re-establishment/handover, one serving cell provides the network access stratum (NAS) mobility information such as tracking area identity (TAD. At RRC connection re-establishment/handover, one serving cell provides the security input. This cell can be referred to as the Primary Cell (PCell). Depending on UE capabilities, Secondary Cells (SCells) can be configured to form, together with the PCell, a set of serving cells.

Dual connectivity can refer to operation where a given UE consumes radio resources provided by at least two different network points (Master and Secondary eNBs) connected with non-ideal backhaul while in RRC_CONNECTED.

A master eNB, in dual connectivity, can be the eNB that terminates S1-MME and therefore act as a mobility anchor towards the core network (CN). A secondary eNB, in dual connectivity, can be an eNB providing additional radio resources for the UE, and which is not the master eNB.

When the UE sends an indication to the network, the indication can include various information. For example, the indication from the UE to the NW can include, for example, an indication that the configured condition is met as well as measurement results of serving and/or neighboring cells. The indication can also include data activity related information such as, for example, when the next transmission is expected—for example, that the next transmission is expected in the next minute is not known, or the like.

A variety of detailed implementations are possible, of which the following are examples. For example, the trigger condition for RRC connection ee-establishment can be configured/signaled for the UE, as mentioned above. Configuration can include, for example, re-establishment triggers for serving cell. The serving cell can refer, for example, to the PCell, SCell or cell of different eNB that is being aggregated by the UE.

The configuration can include radio condition thresholds of own cell which would trigger re-establishment procedure. The thresholds can provide an offset value and hysteresis Qout from lower layers.

The triggers can include a random access problem indication from medium access control (MAC). The triggers can also include an indication from radio link control (RLC) that the maximum number of retransmissions has been reached. The triggers can further include an integrity protection failure. Other triggers can include, for example, that no data was received and/or transmitted during the last X seconds, where X is a predetermined number of seconds.

Configuration can also include, for example, re-establishment triggers associated with a condition of a non-serving cell. For example, a trigger can be a radio trigger of neighbor cell, such as when a neighbor cell becomes better than the serving cell.

Both serving cell and non-serving cell triggers can be evaluated simultaneously. Carrier, frequency, radio access technology (RAT), and cell information can be used for evaluation. This information can be related to serving and non-serving cell(s). Frequency band and RAT can refer to, for example, global system for mobile communications (GSM) edge radio access network (GERAN), universal terrestrial radio access network (UTRAN), enhanced UTRAN (E-UTRAN), wireless local area network (WLAN), WiFi, and the like.

The UE can be mandated to send an indication when the event condition is met. The indication can be, for example, a measurement report. Alternatively the UE can perform re-establishment without indication to the NW. After the indication, if an indication is sent, the UE can perform RRC connection re-establishment.

In an alternative, the network can send a confirmation of reception of the indication as a response to the indication. This confirmation can be, for example, an L1/MAC/RLC level acknowledgement, an RRC level acknowledgement, or a re-establishment command for the UE. The re-establishment command may, in some cases, indicate in which cell(s) the UE is to make its re-establishment. The confirmation can include carrier, frequency, RAT, and/or cell information for the re-establishment.

The above are several example embodiments and illustrations. Although they have been described separately for ease of understanding, they can be used in any combination with one another.

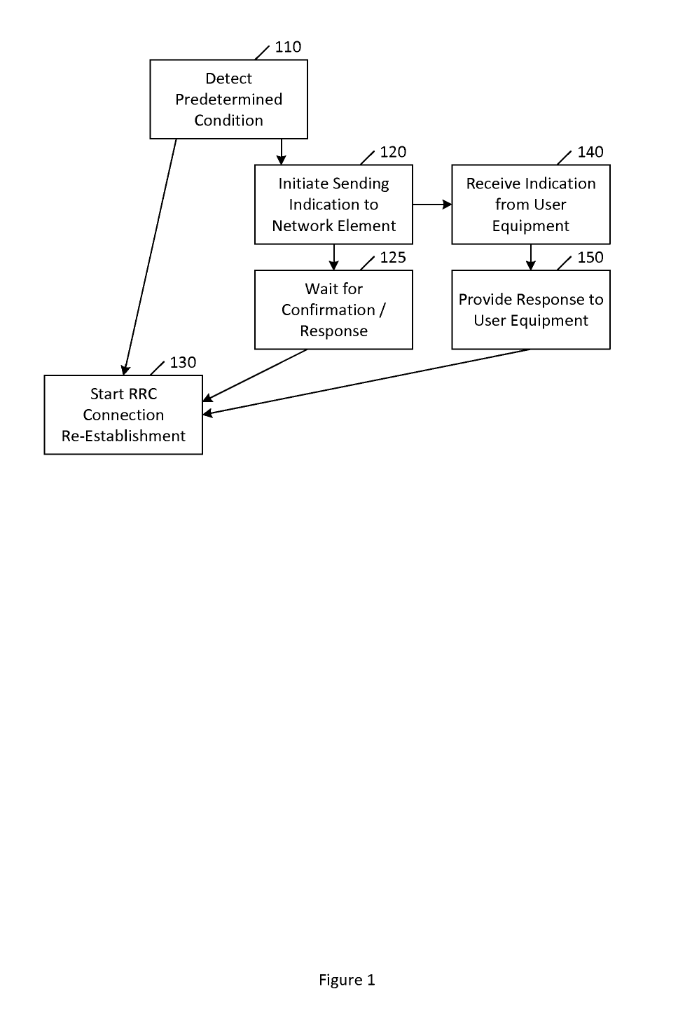

FIG. 1 illustrates a method according to certain embodiments. As shown in FIG. 1, a method can include, at 110, detecting, by a user equipment, a predetermined condition. The predetermined condition can include at least one of a condition of a cell serving the user equipment, a radio condition, a quality related condition, or a data communication condition. Alternatively, the condition of a neighboring cell can be used, either alone or by comparison with the serving cell. The radio condition can be specified in terms of one or more thresholds, as mentioned above. The radio condition can include, for example, RSRP or RSSI, as mentioned above. The quality related condition can include, for example, RSRQ, CQI, or the like, as mentioned above. The data communication condition can refer to data transmission and/or reception activity, such as activity occurring within a predetermined number of seconds prior to the indication.

The method can also include, based on the detected predetermined condition, at least one of, at 120, initiating sending an indication to a network element for delayed radio resource control connection re-establishment or, at 130, starting a radio resource control connection re-establishment. The indication can be configured to indicate that the predetermined condition has been met. The indication can include at least one measurement result of a cell serving the user equipment or a neighbor cell of the cell serving the user equipment. The indication can include data activity related information. The data activity related information can include, for example, data transmission and/or reception activity within a predetermined number of seconds, or an amount of time since last data transmission and/or reception activity.

The method can further include, at 125, after the indication is sent, waiting for confirmation of sent indication or response message from the network element. The starting the radio resource control connection re-establishment can be performed after the waiting.

The method can further include, at 140, receiving the indication at the network element from the user equipment. The indication can indicate that the user equipment has detected a predetermined condition, as mentioned above.

The method can additionally include, at 150, providing a response message from the network element in response to the indication. The response message can be configured to cause the user equipment to start radio resource control connection re-establishment. The response message can be a confirmation that the indication was correctly sent.

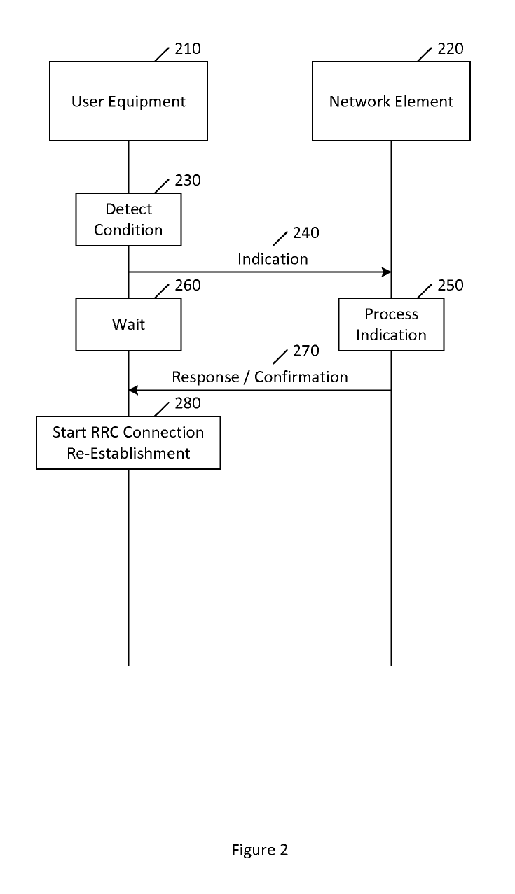

FIG. 2 illustrates a signal flow according to certain embodiments. As shown in FIG. 2, a user equipment 210 can be served by a network element 220, such as a base station, access point, evolved Node B (eNB), relay node, or cluster head. The user equipment 210 can, at 230, detect a condition, as discussed above with reference to FIG. 1, for example. At 240, based on detecting the condition, the user equipment 210 can send an indication to the network element 220.

At 250, the network element 220 can process the indication while at 260 the user equipment 210 waits. Then, if the processing indicates that RRC connection re-establishment is appropriate, the network element 220 can send a response/confirmation to the user equipment 210, at 270.

Finally, at 280, the user equipment 210 can start RRC connection re-establishment. Optionally, as mentioned above, the user equipment 210 can proceed directly from detecting the condition at 230 to starting the RRC connection re-establishment at 280.

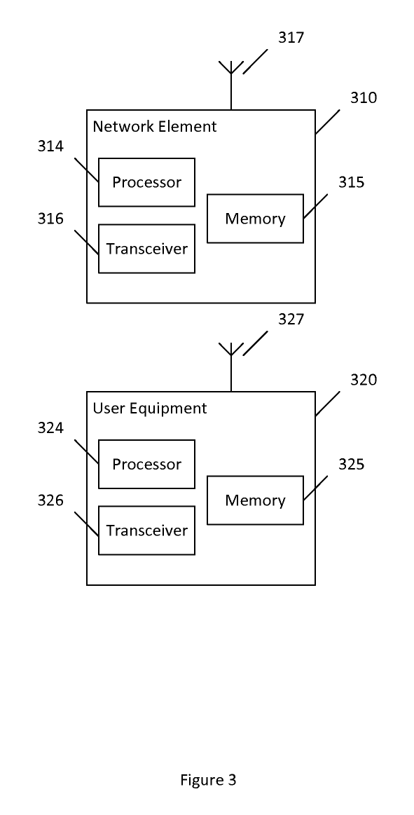

FIG. 3 illustrates a system according to certain embodiments of the invention. It should be understood that each block of the flowchart of FIG. 1 or 2 and any combination thereof may be implemented by various means or their combinations, such as hardware, software, firmware, one or more processors and/or circuitry. In one embodiment, a system may include several devices, such as, for example, network element 310 and user equipment (UE) or user device 320. The system may include more than one UE 320 and more than one network element 310, although only one of each is shown for the purposes of illustration. A network element can be an access point, a base station, an eNode B (eNB), server, host or any of the other network elements discussed herein. Each of these devices may include at least one processor or control unit or module, respectively indicated as 314 and 324. At least one memory may be provided in each device, and indicated as 315 and 325, respectively. The memory may include computer program instructions or computer code contained therein. One or more transceiver 316 and 326 may be provided, and each device may also include an antenna, respectively illustrated as 317 and 327. Although only one antenna each is shown, many antennas and multiple antenna elements may be provided to each of the devices. Other configurations of these devices, for example, may be provided. For example, network element 310 and UE 320 may be additionally configured for wired communication, in addition to wireless communication, and in such a case antennas 317 and 327 may illustrate any form of communication hardware, without being limited to merely an antenna. Likewise, some network elements 310 may be solely configured for wired communication, and such cases antenna 317 may illustrate any form of wired communication hardware, such as a network interface card.

Transceivers 316 and 326 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element deliver local content. One or more functionalities may also be implemented as virtual application(s) in software that can run on a server.

A user device or user equipment 320 may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof.

In an exemplary embodiment, an apparatus, such as a node or user device, may include means for carrying out embodiments described above in relation to FIG. 1 or 2.

Processors 314 and 324 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 315 and 325 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 310 and/or UE 320, to perform any of the processes described above (see, for example, FIGS. 1 and 2). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 3 illustrates a system including a network element 310 and a UE 320, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments may have various benefits or advantages. For example, certain embodiments may provide an LTE-based, simple, power-efficient scheme for small packet transmission, without requiring an excessive number of changes to the specifications, as a disruptive technology.

Certain embodiments may have various benefits or advantages. For example, in certain embodiments, RRC connection re-establishment procedure may be optimized. Furthermore, in certain embodiments, UE behavior may be more predictable. Other benefits and advantages may also be present.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### Partial Glossary

3GPP third generation partnership project

DRX discontinuous reception

eNB enhanced NodeB

E-UTRA evolved universal terrestrial radio access

HetNet heterogeneous network

HOF handover failure

KPI key performance indicator

MSE Mobility State Estimation

MTC machine type communication

RLF radio link failure

RRC radio resource control

SI system information

TS technical specification

UE user equipment

1.-92. (canceled)

93. A method, comprising:
detecting, by a user equipment, a predetermined condition; and
based on the detected predetermined condition, initiating sending an indication to a network element,
wherein said indication comprises at least one of:
a measurement result of a cell serving the user equipment,
a measurement result of a neighbor cell,
a random access problem indication, or
an indication from radio link control (RLC) that a maximum number of retransmissions has been reached.

94. The method of claim 93, further comprising:
based on the detected predetermined condition, starting a radio resource control connection re-establishment.

95. The method of claim 93, further comprising:
after the indication is sent, waiting for confirmation of sent indication or response message from the network element.

96. The method of claim 93, wherein the predetermined condition comprises at least one of a condition of a cell serving the user equipment, a radio condition, a quality related condition, or a data communication condition.

97. The method of claim 96, wherein the radio condition comprises at least one of
a reference signal received power, and
a presence or absence of transmission and/or reception during a last X seconds, where X is a predefined number of seconds.

98. The method of claim 93, wherein the random access problem indication is from medium access control (MAC).

99. The method of claim 93, wherein the condition comprises an integrity protection failure.

100. The method of claim 93, wherein said predetermined condition is related to a secondary cell or to a secondary eNB providing resource from a different access point.

101. The method of claim 93, wherein said predetermined condition comprises a random access failure of a secondary eNB and wherein said indication from radio link control (RLC) that the maximum number of retransmissions has been reached is from the secondary eNB.

102. A method comprising:
receiving an indication at a network element from a user equipment, wherein the indication indicates that the user equipment has detected a predetermined condition, said indication comprises at least one of
a measurement result of a cell serving the user equipment,
a measurement result of a neighbor cell,
a random access problem indication, or
an indication from radio link control (RLC) that a maximum number of retransmissions has been reached; and
providing a response message from the network element in response to the indication, wherein the response message is configured to cause the user equipment to start radio resource control connection re-establishment.

103. The method of claim 102, wherein said predetermined condition is related to a secondary cell or to a secondary eNB providing resource from a different access point.

104. The method of claim 102, wherein said predetermined condition comprises a random access failure of a secondary eNB and wherein said indication from radio link control (RLC) that the maximum number of retransmissions has been reached is from the secondary eNB.

105. A non-transitory computer-readable medium encoded with instructions that, when executed in hardware, perform a process, the process comprising the method according to claim 93.

106. An apparatus, comprising:
at least one processor; and
at least one memory including computer program code,
wherein the at least one memory and the computer program code are configured to, with the at least one processor, cause the apparatus at least to
detect, by a user equipment, a predetermined condition; and
based on the detected predetermined condition, initiate sending an indication to a network element,
wherein said indication comprises at least one of
a measurement result of a cell serving the user equipment,
a measurement result of a neighbor cell,
a random access problem indication, or
an indication from radio link control (RLC) that a maximum number of retransmissions has been reached.

107. The apparatus of claim 106, wherein the at least one memory and the computer program code are configured to, with the at least one processor, cause the apparatus at least to, based on the detected predetermined condition, start a radio resource control connection re-establishment.

108. The apparatus of claim 106, wherein the random access problem indication is from medium access control (MAC).

109. The apparatus of claim 106, wherein said predetermined condition is related to a secondary cell or to a secondary eNB providing resource from a different access point.

110. The apparatus of claim 106, wherein said predetermined condition comprises a random access failure of a secondary eNB and wherein said indication from radio link control (RLC) that the maximum number of retransmissions has been reached is from the secondary eNB.

111. An apparatus, comprising:
at least one processor; and
at least one memory including computer program code,
wherein the at least one memory and the computer program code are configured to, with the at least one processor, cause the apparatus at least to
receive an indication at a network element from a user equipment, wherein the indication indicates that the user equipment has detected a predetermined condition, wherein the indication indicates that the user equipment has detected a predetermined condition, said indication comprising at least one of
a measurement result of a cell serving the user equipment,
a measurement result of a neighbor cell,
a random access problem indication, or
an indication from radio link control (RLC) that a maximum number of retransmissions has been reached; and
provide a response message from the network element in response to the indication, wherein the response message is configured to cause the user equipment to start radio resource control connection re-establishment.

112. The apparatus of claim 111, wherein said indication comprises at least one of
a measurement result of a cell serving the user equipment,
a measurement result of a neighbor cell,
a random access problem indication, or
an indication from radio link control (RLC) that a maximum number of retransmissions has been reached.
